(19) United States
(12) Patent Application Publication
(10) Pub. No.: US 2021/0125077 A1
(43) Pub. Date: Apr. 29, 2021

(54) SYSTEMS, DEVICES AND METHODS FOR TRANSFER LEARNING WITH A MIXTURE OF EXPERTS MODEL

(71) Applicant: THE GOVERNING COUNCIL OF THE UNIVERSITY OF TORONTO, Toronto (CA)

(72) Inventors: Sanja Fidler, Toronto (CA); David Jesus Acuna Marrero, Toronto (CA); Xi Yan, Toronto (CA)

(21) Appl. No.: 17/032,910

(22) Filed: Sep. 25, 2020

Related U.S. Application Data
(60) Provisional application No. 62/926,138, filed on Oct. 25, 2019.

(51) Int. Cl. G06N 3/08; G06N 3/04

(52) U.S. Cl. CPC G06N 3/088; G06N 3/04

(57) ABSTRACT

A computer-implemented method for selecting training data for a neural network, which includes representing a dataset with a mixture of experts model, the mixture of experts model comprising one or more trained neural networks; and generating an application dataset based on one or more performance indicators of one or more of the trained neural networks. Representing the dataset with the mixture of experts model can include partitioning the dataset into one or more data subsets and training one or more neural networks each on one of the data subsets to generate the one or more trained neural networks. A platform for training a neural network and a computer product for carrying out the steps of the method are also described.

### FIELD OF THE INVENTION

The present disclosure generally relates to the field of transfer learning in artificial intelligence (AI), and, in particular, to systems, devices and methods for transfer learning with a mixture of experts model.

### BACKGROUND OF THE INVENTION

There has been an explosive growth in both the number and variety of AI applications. These range from image classification tasks, to surveillance, sports analytics, clothing recommendation, early disease detection, and mapping.

AI applications often use massive amounts of data to train deep learning models. Transfer learning can be used in some domains to train AI technology.

### SUMMARY OF THE INVENTION

In accordance with an aspect, there is provided a computer-implemented method for training a neural network. The method includes representing a dataset with a mixture of experts model, the mixture of experts model comprising one or more trained neural networks, as well as generating an application dataset based on one or more performance indicators of one or more of the trained neural networks.

In some embodiments, representing the dataset with the mixture of experts model includes partitioning the dataset into one or more data subsets and training one or more neural networks each on one of the data subsets to generate the one or more trained neural networks.

In some embodiments, the partitioning includes k-means clustering over a set of features of a class of the dataset.

In some embodiments, the partitioning includes k-means clustering over a set of features of a pretrained neural network.

In some embodiments, the training of the one or more neural networks includes self-supervised training on a pretext task.

In some embodiments, the method includes adapting one of the one or more trained neural networks on a client dataset to generate one of the one or more performance indicators.

In some embodiments, the method includes evaluating the performance of one of the one or more trained neural networks on a client dataset to generate one of the one or more performance indicators.

In some embodiments, the one or more performance indicators are generated by adapting one of the one or more trained neural networks on a client dataset when a first task for the dataset is the same as a second task for the application dataset; and evaluating the performance of one of the one or more trained neural networks on the client dataset when the first task is not the same as the second task or when the second task is unknown.

In some embodiments, the application dataset is generated by sampling data points from the dataset at a rate according to a data point weighting generated for each of the data points, each data point weighting based on one of the one or more performance indicators.

In some embodiments, the one or more performance indicators are generated at a client.

In some embodiments, the method includes transmitting the application dataset to a client for use in a target application.

In accordance with an aspect, there is provided a server storing a representation of a dataset by a mixture of experts model, the mixture of experts model comprising one or more trained neural networks; and an application dataset generated based on one or more performance indicators of one or more of the trained neural networks.

In some embodiments, the one or more trained neural networks are generated by training one or more neural networks each on one of the data subsets, the data subsets generated by partitioning the dataset.

In some embodiments, the application dataset is generated by sampling data points from the dataset at a rate according to a data point weighting generated for each of the data points, each data point weighting based on one of the one or more performance indicators.

In accordance with an aspect, there is provided a computer product with non-transitory computer readable media storing program instructions to configure a processor to represent a dataset with a mixture of experts model, the mixture of experts model comprising one or more trained neural networks; and generate an application dataset based on one or more performance indicators of one or more of the trained neural networks.

In some embodiments, the instructions configure the processor to represent the dataset with the mixture of experts model by partitioning the dataset into one or more data subsets and training one or more neural networks each on one of the data subsets to generate the one or more trained neural networks.

In some embodiments, the instructions configure the processor to generate the application dataset by sampling data points from the dataset at a rate according to a data point weighting generated for each of the data points, each data point weighting based on one of the one or more performance indicators.

Other aspects and features and combinations thereof concerning embodiments described herein will be become apparent to those ordinarily skilled in the art upon review of the instant disclosure of embodiments in conjunction with the accompanying figures.

### BRIEF DESCRIPTION OF THE DRAWINGS

In the figures, embodiments are illustrated by way of example. It is to be expressly understood that the description and figures are only for the purpose of illustration and as an aid to understanding. Embodiments will now be described, by way of example only, with reference to the attached figures, wherein in the figures:

FIG. 1 is a schematic diagram of an example platform for transfer learning using a mixed experts model, according to an embodiment;

FIG. 2 is a flow diagram of an example method using a mixed experts model, according to an embodiment;

FIG. 3 are images from target and source datasets, according to an embodiment;

FIG. 4 is a schematic diagram an example platform, according to an embodiment;

FIG. 5 is a graph showing a relationship between domain classifier and proxy task performance, according to an embodiment; and

FIGS. 6A, 6B, 6C, 6D, 6E, 6F, 6G, and 6H display graphs showing transfer learning on object detection and instance segmentation, according to an embodiment.

Like reference numerals indicated like or corresponding elements in the drawings.

### DETAILED DESCRIPTION OF THE EMBODIMENTS

Transfer learning can be a successful way to train high performing deep learning models in various applications for which little labeled data is available. In transfer learning, one pre-trains a model on a large dataset such as Imagenet, and fine-tunes its weights on the target domain. In the new era of an ever-increasing number of massive datasets, selecting the relevant pretraining data is a critical issue. To address this issue, available datasets can be stored in one centralized location called a dataserver. A client, such as a target application with its own small labeled dataset, may be only interested in fetching a subset of the server's data that is most relevant to its own target domain.

Embodiments described herein provide a platform and method for transfer learning using a mixture of experts, such as a mixture of self-supervised experts. The platform and method can enable improved training and application of machine learning and other artificial intelligence technology by curating data most useful for the training and/or application of the machine learning or other artificial intelligence technology such as for a particular application dataset or purpose. The determination and selection of that data to be used in training a machine learning or other artificial intelligence technology at a client for a particular client dataset or application uses a mixture of experts model in some embodiments. For example, embodiments described herein provide a method that preferentially selects subsets of data from the dataserver given a particular target client. Data selection is performed by employing a mixture of experts model in a series of dataserver-client transactions with a small computational cost, according to some embodiments. Some embodiments of this method and its level of effectiveness can be shown in various transfer learning scenarios, demonstrating performance on several target datasets and tasks such as image classification, object detection, and instance segmentation. The framework can be made available as a web service, serving data to users aiming to improve performance in their AI application.

There exists a large number and variety of AI applications. These range from image classification tasks, to surveillance, sports analytics, clothing recommendation, early disease detection, and mapping, among others. Deep learning can have many other possible applications and capabilities.

Some artificial intelligence applications need labeled data. To achieve high-end performance, a massive amount of data can be used to train deep learning models. One way to mitigate the need for large-scale data annotation for each target application is via transfer learning in which a neural network is pre-trained on existing large-scale datasets and then fine-tuned on the target downstream task. While transfer learning is a well-studied concept that may be successful in many domains, deciding which data to pre-train the model on is a crucial problem to be answered in light of the ever-increasing scale of the available data.

An example website of curated computer vision benchmarks lists 367 public datasets, ranging from generic imagery, faces, fashion photos, to autonomous driving data. The sizes of datasets have also massively increased: for example, a dataset can contain 9M of labeled images (600 GB in size) that are 20 times larger compared to predecessor datasets (330K images at 30 GB). As another example, a video benchmark dataset can contain 1.9B frames at 1.5 TB and can be 800 times larger compared to previous datasets that contain 10k frames at 1.8 GB. As another example, an autonomous driving dataset can contain 100 times the number of images than previous datasets.

Downloading and storing all these datasets locally may not be affordable for everyone, let alone pre-training a model on this massive amount of data. Furthermore, for commercial applications, data licensing may be considered. There is not necessarily a “the more the better” relationship between the amount of pre-training data and the downstream task performance. Instead, selecting an appropriate subset of pre-training data can be important to achieve good performance on the target dataset.

Transfer Learning

The success of deep learning and the difficulty of collecting large scale datasets brings attention to transfer learning, cross-domain annotation and domain adaptation. Specifically in the context of neural networks, fine-tuning a pre-trained model in a new dataset is a strategy for knowledge transfer. Models can be pre-trained in an “enormous data” scenario. That is, pre-training can be performed on datasets that are 300 times and 3000 times larger than some previous datasets. Transfer learning can be applied in in neural networks. In particular, various factors can affect the transferability of representations learned, for example, on convolutional neural networks, with respect to network architectures, network layers, and training tasks. A computational method for modelling the transferability between visual tasks can be provided. The choice of pre-training data can impact performance on fine-grained classification tasks. Specifically, pre-training on only relevant examples can be important to achieve good performance. Embodiments described herein can present a scalable and efficient way to select the most useful subset of data in a distributed scenario where the transactions between a datacenter and a client should be both computationally efficient and privacy-preserving. Embodiments of the platform described herein advantageously can be used in a variety of tasks, not simply classification, as well as where the task type of an original dataset or trained neural networks (e.g., mixture of experts) differs from the task type of the application dataset or neural networks trained by transfer learning.

Federated Learning

A distributed machine learning approach with the goal of training a centralized model on decentralized data over a large number of client devices (e.g., mobile phones) can be used. Embodiments described herein can likewise restrict the visibility of data in a client-server model. However, in some of these embodiments, the data is centralized in a server and the clients exploit a transfer learning scenario.

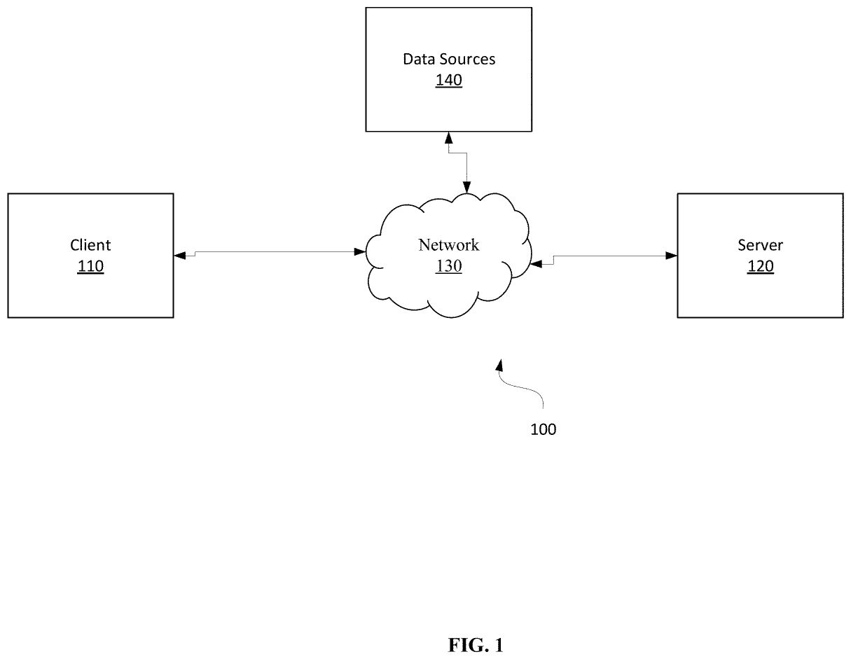

FIG. 1 is a schematic diagram of an example platform 100 for providing an application dataset to a client based on its relevancy to the client application using a mixture of experts model. In some embodiments, all datasets (e.g., public datasets) are stored in one centralized location, such as a dataserver at server 120, and made available for download per request by a client 110. In some embodiments data sources 140 include databases and are accessible by the server 120 over a network 130 to store and retrieve data. A client 110 can be a computer or user application with its own AI application and, in some cases, has a small set of its own labeled target data. Each client may only request for download a subset of the server's data that is most relevant to its own target domain. This subset of data can be limited to a pre-defined budget (maximum allowed size). The transaction between the dataserver 120 and the client 110 can be implemented by data transmission over network 130 and can be efficient computationally, as well as privacy-preserving. For example, the client 110's data may not be visible to the server 120, and the server 120 can be configured to minimize the amount of computation per client 110, as the server 120 may serve many clients 110 in parallel. In some embodiments, this can be provided by the use of a mixture of experts model to represent the dataset at server 120, where client 110 receives the mixture of experts (or subset of same) instead of raw data from server 120. Similarly, in some embodiments, client 110 provides a performance indicator (e.g., data representation) to the server to indicate which expert(s) performed well on its application dataset or for its particular artificial intelligence task, instead of providing its raw application data to the server 120. Server 120 determines, selects, and/or generates data from the server 120 dataset that corresponds to the expert(s) having high performance indications and provides same to client 110, according to some embodiments. The data can be referred to as an application dataset or target dataset of the client 110 and may be preferentially curated (e.g., selected) to provide a desired level of performance for client 110's target application.

In some embodiments, there is provided a platform 100 and method that are configured to preferentially, optimally, or adaptively select subsets of data from a dataserver 120 given a particular target client 110. In particular, in some embodiments, the platform 100 is configured to represent the server's 120 data with a mixture of experts model. The mixture of experts model can be trained with a simple self-supervised task. In some embodiments, the platform 100 can allow all of the server's 120 data to be distilled or otherwise represented at the server in a more useful way, such as computationally more efficient in access or retrieval or such as advantageously partitioned to allow selection by the server 120 or in a client 110 request for data relevant to a particular computer application by the client 110. For example, the platform 100 can enable a representation of the server's 120 data, even when the server's 120 data consists of several datasets featuring different types of labels, as the weights of a small number of experts. In some embodiments, these experts are then used on the client's 110 side to determine the most important subset of the data that the server 120 can provide to the client 110. The platform 100 according to some embodiments provides significant improvements in performance on all downstream tasks compared to pre-training on a randomly selected subset of the same size. In particular, with only 20% or 40% of pre-training data, some embodiments of the platform 100 achieve comparable or better performance than pre-training on the entire server's 120 dataset.

In some embodiments, the platform 100 is implemented as a web platform, such as including dataserver 120 that links to a variety of large datasets, and enables each client 110 to only download the relevant subset of data.

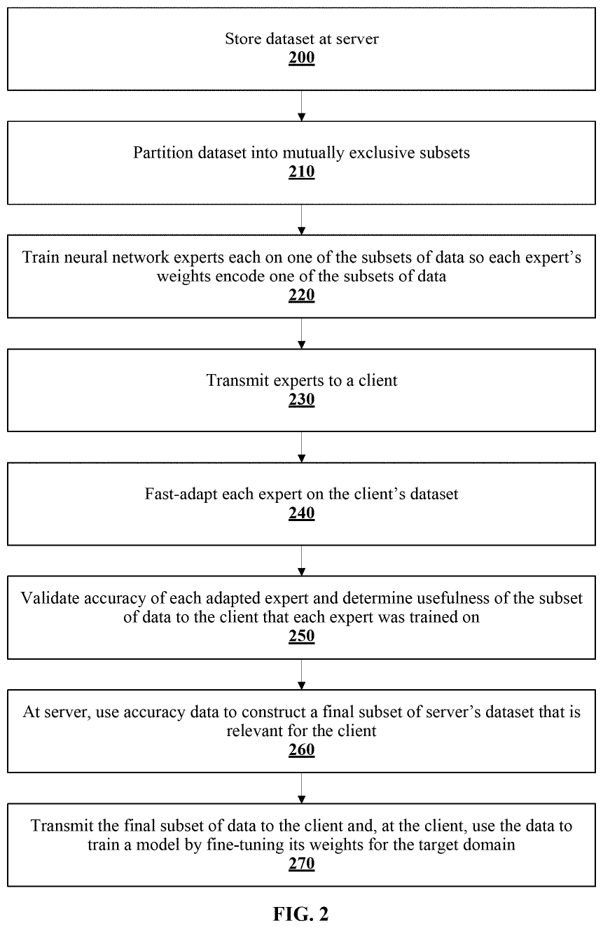

FIG. 2 is a flow diagram of an example method for platform 100, according to some embodiments. As shown, platform 100 represents a dataset with a mixture of experts model, the mixture of experts model comprising one or more trained neural networks, as well as generates an application dataset based on one or more performance indicators of one or more of the trained neural networks. A dataset can include a collection of datasets. At 200, platform 100, such as at server 120, stores a dataset. The dataset can include all labelled data points, no labelled data points, or a combination of labelled and non-labelled data points. The label types can vary across the data points. At 210 and 220, platform 100, such as at server 120, represents the dataset with a mixture of experts model. In some embodiments, the mixture of experts model is generated by partitioning the dataset into data subsets at 210 and training an expert each on one of the data subsets at 220. This can allow each expert's weights to represent (e.g., encode) one of the data sub sets.

In some embodiments, a dataserver 120, e.g., a centralized database that has access to a massive source dataset, provides relevant subset of data to a client 110 that wants to improve the performance of its model on a downstream task by pre-training the model on this subset. The dataserver 120's dataset may or may not be completely labeled, and the types of labels (e.g., masks for segmentation, boxes for detection, or scene attributes) across data points may vary. The client 110's dataset may only have a small set of labeled examples, where further the task (and thus the type of its labels) may or may not be the same as any of the tasks defined on the dataserver 120's dataset(s). There are challenges in enabling the dataserver 120-client 110 transactions to be scalable (on the server 120 side) with respect to the number of clients 110 and affordable for the resource-limited client 110 (e.g., cannot pre-train on a massive dataset), as well as privacy-preserving (e.g., client 110's data cannot be shared with the server 120). For example, client 110 may have sensitive data such as hospital records or may have target applications that involve or use the sensitive data. In some embodiments, only the most relevant data points are transmitted from the server 120 to the client 110. In some embodiments, platform 100 addresses or mitigates these challenges thereby improving the functionality of computer-implemented transfer learning.

As an example, in some embodiments, platform 100 represents the dataserver's 120 data using a mixture of experts learned (e.g., only once) on a self-supervised task. This naturally partitions the datasets into K different subsets of data and produces specialized neural networks whose weights encode the representation of each of those subsets. These experts are cached on the server 120 and shared with each client 110, and used as a proxy to determine the importance of data points for the client 110's task. In particular, the experts are downloaded by the client 110 and fast-adapted on the client 110's dataset, in some embodiments. The accuracy, such as represented by a performance indicator, of each adapted expert can be experimentally validated to indicate the usefulness of the data partition used to train the expert on the dataserver 120. The server 120 then uses these accuracies, such as represented by a performance indicator, to construct the final subset of its data that is relevant for the client 110. This subset of data is used by client 110 to train or fine-tune its artificial intelligence or machine learning systems, which are then used to perform the respective task (e.g., classification) on an application dataset at the client 110 with improved performance (e.g., accuracy).

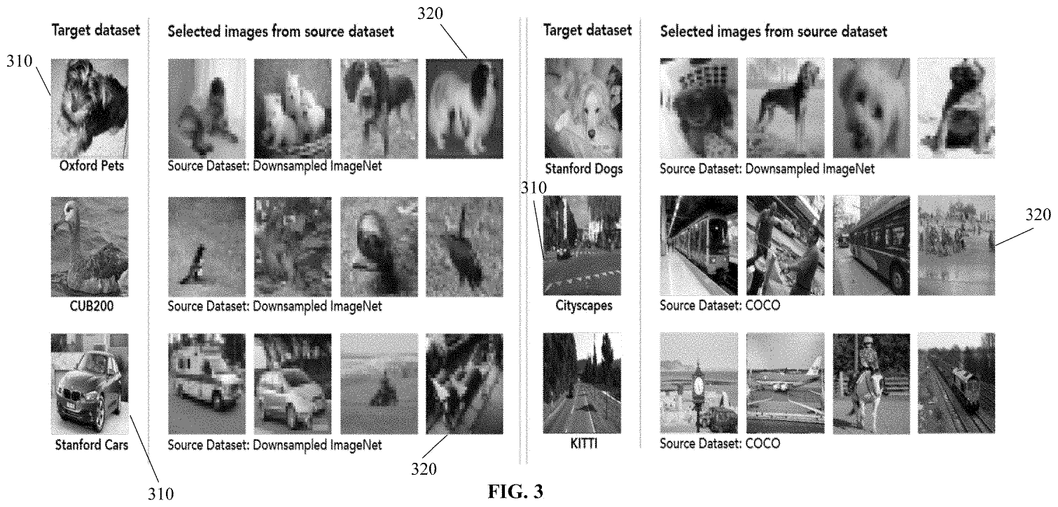

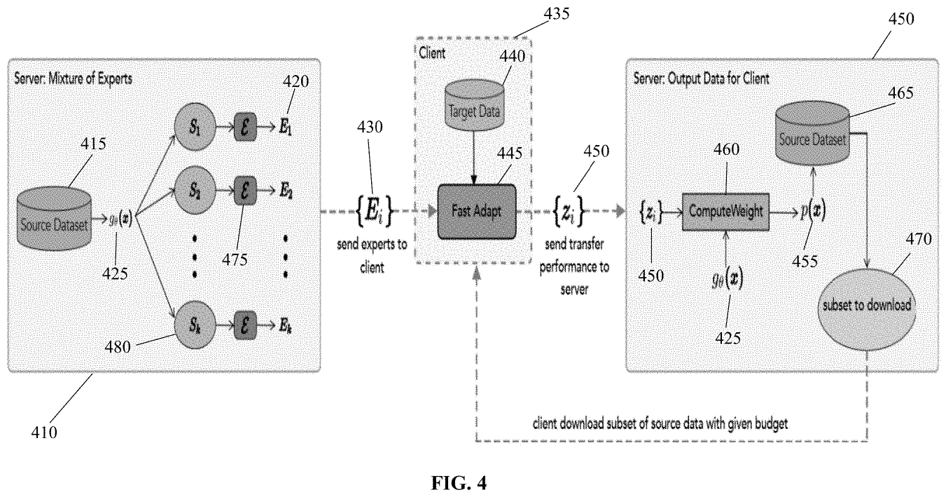

FIG. 3 shows example images 310 in target datasets of a client 110, as well as example images 310 selected from the source dataset at server 120. For example, if target dataset 310 include images of pets, platform 100 constructs a dataset 320 having similar images of pets and provides same to client 110, for example. FIG. 4 is a schematic diagram illustrating a framework of platform 100 and a method as presented in Algorithm 2.

FIG. 4 is a schematic diagram of an example method for platform 100, according to some embodiments. Platform 100 includes a server having one or more servers 410, 450 and one or more clients 435. In some embodiments, server 410 and 450 are a single server. Server 410 is configured to store a source dataset 415 in a data structure in a database. Server 410 is configured to execute instructions in memory to partition 425 the dataset 415 into one or more data subsets 480 each encoded by an expert 475, transmit one or more of the experts 475 to a client 435, receive performance indicators of each expert 475 from the client, and generate an application dataset 470 based on one or more performance indicators of one or more of the experts 175. A performance indicator can be data representing a level of relevancy of the respective expert 475 to a particular target application at the client.

The problem and task solved by platform 100 in some embodiments is elaborated as follows. Let X denote the input space (images in this paper), and Ya a set of labels for a given task a. Generally, we will assume that multiple tasks, each associated with a different set of labels, are available, and denote this by Y. Consider also two different distributions over X×Y called the source domain Dₛ and target domain Dₜ. Let S (server 120) and T (client 110) be two sample sets drawn independent and identically distributed (i.i.d.) from Dₛ and Dₜ, respectively. |S| |T| is assumed. Platform 100 finds the subset S_{*}⊂P(S), where P(S) is the power set of S, such that S_{*}∪T minimizes the risk of a model h on the target domain:

$${S}_{*} = {arg min}_{\hat{𝒮} ⋐ 𝒫 ( 𝒮 )} {𝔼}_{( x , y ) ∼ {𝒟}_{t}} [ L ( {h}_{\hat{𝒮} ⋃ 𝒯} ( x ) , y ) ] \qquad ( 1 )$$

Here, h_{S∪T}\hat{ } indicates that h is trained on the union of data S\hat{ } and T. Intuitively, platform 100 at server 120 constructs (e.g., generates and/or selects) the subset of data from S that helps to improve the performance of the model on the target dataset at client 110. In some embodiments, platform 100 performs this construction while also restricting the visibility of the data between the dataserver 120 and the client 110. For example, fetching the whole sample set S is prohibitive for the client 110, as it is uploading client 110's dataset to the server 120, according to some embodiments of platform 100. Platform 100 performs the desired construction of the subset of data, while restricting the visibility of the data between dataserver 120 and client 110 by representing the dataserver 120's dataset with a set of classifiers that are agnostic of the client 110, and these are used by platform 100 (e.g., at server 120) to optimize equation 1 on the client's side (Sec. 3.3.1).

Algorithm 1 Server modules

| | |
|---|---|
| 1: | Initialize representation learning algorithm ε, |
| | number of experts K |
| 2: | g_{θ} ← HARDGATING(S, K) [symbol] Section 3.2: partition |
| | S into local subsets to obtain gating |
| 3: | |
| 4: | procedure MOE(S, ε, K): |
| 5: | For i = 1, . . . , K |
| 6: | Run ε on {x ∈ S\|g_{θ}(x)ᵢ = 1} |
| | to obtain expert e_{θ}_{ⱼ} |
| 7: | return {e_{θ}_{ᵢ}} |
| 8: | |
| 9: | procedure OUTPUTDATA(S, z): |
| 10: | w ← Softmax(Normalize(z)) |
| 11: | $p ( x ) = {\sum }_{i = 1}^{K} {w}_{i} {g}_{{i}_{θ}} ( x ) \frac{1}{\vert {S}_{i} \vert}$ |
| 12: | Sample S₊ from S at rate according to p |
| 13: | return S_{*} |

Algorithm 2 Overview of our framework.

| | |
|---|---|
| 1: | Input: S, T |
| 2: | { [symbol] }←MoE(D [symbol] , E , K) |
| 3: | z ←FASTADAPT(T [symbol] { [symbol] }) |
| 4: | S [symbol] ←OUTPUTDATA(S, z, b) |
| 5: | return S [symbol] |
| 6: | Output: S [symbol] ∈ S to download |

[symbol]

indicates data missing or illegible when filed

Algorithm 3 Client module

| | |
|---|---|
| 1: | procedure FASTADAPT(D [symbol] { [symbol] }): |
| 2: | Initialize logits z ∈ [symbol] K |
| 3: | For i = [symbol] . . . , K |
| 4: | z [symbol] ←PERFORMANCE( [symbol] T) [symbol] Section |
| | 3.3.1 [symbol] Evaluate transfer performance of E [symbol] on T |
| 5: | return z |

[symbol]

indicates data missing or illegible when filed

Dataset Representation with a Mixture of Experts

Expert models can be obtained through a mixture of experts and server 120 is configured to implement one or more of different choices of representation learning algorithms for the experts (server side).

In some embodiments, platform 100 computes a representation of server 120 (e.g., its dataset) once and stores same on the server 120. For example, dataserver 120's data S is represented using a mixture of experts model. Server 120 implements the mixture of experts model by making a prediction as:

$$y ( x ) = {\sum }_{i = 1}^{K} {g}_{θ} ( x ) {e}_{{θ}_{i}} ( x ) \qquad ( 2 )$$

Here, g_{θ} denotes a gating function, e_{θi} denotes the i-th expert model given an input x, θ are learnable weights of the model, and K corresponds to the number of experts. The gating function softly assigns data points to each of the experts, which try to make the best guess on their assigned data points. Platform 100 at server 120 chooses the data relevant to client 110 by 1) estimating the relevance of each expert on the client 110's dataset, and 2) using the gating function as a means to measure relevance of the original data points. The chosen data is used to construct the dataset that is a subset of the dataset at the server 120 and that improves the performance of the model on the target dataset at client 110.

In some embodiments, platform 100 at server 120 trains the experts as follows. The mixture of experts model is learned by defining an objective L and using maximum likelihood estimation (MLE):

$$θ = {arg min}_{θ} {𝔼}_{( x , \hat{y} ) ∼ 𝒮} [ ℒ ( y ( x ) , \hat{y} ) ] \qquad ( 3 )$$

The objective L can be selected to accommodate embodiments where labels across the source datasets are defined for different tasks.

While, in some embodiments, this objective can be trained end-to-end (e.g., without partitioning the dataset into mutually exclusive subsets), the computational cost of doing so on a massive dataset can be extremely high, particularly when K is relatively large (e.g., this can require backpropagating gradients to every expert on every training example). In some embodiments, platform 100 at server 120 is configured to alleviate this issue by associating each expert with a local cluster defined by a hard gating. The hard gating can help ease computational requirements. For example, server 120 is configured to define a gating function g that partitions the dataset into mutually exclusive subsets, and train one expert per subset. This can allow training to be parallelized as each expert can be trained independently on its own subset of data and facilitate the training in some embodiments.

In particular, either of two partitioning schemes can be implemented by server 120 to determine the gating: (1) superclass partition, and (2) unsupervised partition. In superclass partitioning, each class c in the source dataset is represented as the mean of the image features f_{c} for category c, and k-means clustering is performed over {f_{c}}. This can provide a partitioning where each cluster is a superclass containing a subset of similar categories. In unsupervised partitioning, the source dataset is partitioned using k-means clustering on the feature space of a pretrained neural network (i.e., features extracted from the penultimate layer of a network pre-trained on ImageNet).

Training the Experts

In some embodiments, platform 100 at server 120 trains the experts as follows. In some embodiments, the tasks defined for both the server 120's and client 110's datasets are the same, for example, classification. Platform 100 at server 120 trains a classifier for each subset of the data in S.

In some embodiments, the tasks for the server 120's dataset and the client 110's dataset are different. For example, the client 110's dataset may be used by a client 110 application implementing an artificial intelligence technology for a different task than the server 120's dataset would be used to train the experts on. The client task may not be known during the server 120 indexing process (e.g., while training the expert models such as at the server 120). Platform 100 at server 120 is configured to generate or learn a representation that can generalize to a variety of downstream tasks and can therefore be used in a task-agnostic fashion. For example, the same representation generated can be advantageously used for a variety of different clients 110, each with different tasks defined for their respective datasets.

Platform 100 at server 120 implements a self-supervised method on a pretext task to train the mixtures of experts, according to some embodiments. In particular, a simple surrogate task is used to learn a meaningful representation. This does not require any manually labeled data to train the experts. In some embodiments, this can allow for dataserver 120's dataset to be labeled or not to be labelled beforehand. This can be useful for allowing server 120 to transmit raw data to client 110 and allowing client 110 to label the relevant subset on its own at client 110.

As an example pretext task, platform 100 at server 120 is configured to select and implement image rotation as a pseudo-task for self-supervision. This can be a simple yet powerful proxy for representation learning. In particular, given an image x, its corresponding label y is defined by performing a set of geometric transformations {r(⋅,j)}³ⱼ₌₀ on x, where r is an image rotation operator, and j defines a particular rotation by one of the following predefined degrees {0,90,180,270}. Server 120 is configured to then minimize the following learning objective for the mixture of experts:

$$ℒ ( x ) = \frac{1}{4} {\sum }_{j = 0}^{3} log {y}_{j} ( r ( x , j ) ) \qquad ( 4 )$$

Dataset Selection for Client

In some embodiments, the experts' performance on the client 110's task is used by platform 100 at server 120 for data selection. Referring to FIG. 2, at 230, the platform, such as at server 110, transmits one or more experts to a client 135. The transmission can be initiated on request by the client 135, for example. The client 135 can use the one or more experts to assess the relevancy of each transmitted expert for the client's 135 target application. In some embodiments, one or more of the experts are adapted at 240 to a target dataset at the client 135, such as where the dataset task is the same for both the client and the server. In some embodiments, the experts are not adapted to the target dataset at the client 135, such as where the dataset task of the client and the dataset task of the server are different or where labels for datapoints in the client dataset is not available.

In some embodiments, platform 100 is configured to implement a transaction between server 120 and client 110 that allows a relevant subset of the server 120's data to be determined, generated, or otherwise constructed. Client 110 first downloads the experts and uses these experts to measure their performance on the client 110's dataset. In some embodiments, client 110 is configured to perform a quick adaptation of the experts (e.g., to a client 110's dataset), for example, to address any domain gap between the source and the target datasets. The performance of each expert is sent back to the server such as represented as a performance indicator (e.g., data). Server 120 is configured to use this data as a proxy to determine which data points are relevant to the client.

In some embodiments, client 110 is configured to adapt one or more trained neural networks (e.g., from server 120) on its client 110 dataset to generate one or more performance indicators.

In some embodiments, the dataset task is the same for both the client 110 and the server 120 (e.g., classification). While the task may be the same, the label set may not be (e.g., classes may differ across domains). Client 110 is configured, in some embodiments, to adapt the experts by removing their classification head that was trained on the server and learn a small decoder network on top of the experts' penultimate representations on the client's dataset. The decoder can help make the adapted experts agnostic as the decoder can be fine-tuned for client 110. For example, for classification tasks, client 110 is configured to learn a simple linear layer on top of each pre-trained expert's representation for a few epochs. Client 110 is configured to then evaluate its target's task performance on a held-out validation set using the adapted experts. The accuracy for each expert i can be denoted as zᵢ.

In some embodiments, client 110 is configured to evaluate the performance of one or more trained neural networks (e.g., from server 120) on a client 110 dataset to generate one of the one or more performance indicators.

In some embodiments, the dataset task is diverse as between the server 120 and client 110. Server 120 is configured, in some embodiments, to generalize to unseen tasks and be further able to handle cases where the labels are not available on the client 110's side. In particular, server 120 is configured to evaluate the performance of the common self-supervised task used to train the experts on the server 120's data. If the expert performs well in the self-supervised task on the target dataset, then server 120 is configured to determine that the data it was trained on is likely relevant for the client 110. Specifically, server 120 is configured to use the self-supervised experts trained to learn image rotation and evaluate the proxy task performance of predicting image rotation angles on the target images:

$${z}_{i} = \frac{1}{\vert 𝒯 \vert} {\sum }_{x ∈ 𝒯} [ {arg min}_{j} {\{ {e}_{θ} , ( r ( x , j ) ) \}}_{j = 0}^{3} = j ] \qquad ( 5 )$$

In this case, client 110 is not configured to adapt the experts on the target dataset. Only an inference is made.

In some embodiments, the one or more performance indicators are generated by adapting one or more trained neural networks on the client 110 dataset when a first task for the dataset is the same as a second task for the application dataset; and evaluating the performance of one or more trained neural networks on the client 110 dataset when the first task is not the same as the second task or when the second task is unknown.

Referring to FIG. 2, at 250, platform 100, such as at server 110, receives a performance indicator of each adapted expert and determines the usefulness of the subset represented by the expert to the client. At 260, platform 100, such as at server 110, uses performance indicators to select a final subset of the server's data that is relevant for the client. At 270, the final subset of data is transmitted to the client. The client can use the data to train a model by fine-tuning the model's weights for the target domain.

In some embodiments, server 120 is configured to assign a weighting to each of the data points in the source domain S to reflect how well the source data contributed to the transfer learning performance. For example, this can be performed as follows. The accuracies zᵢ from the client 110's FASTADAPT step for each expert are normalized to [0,1] and fed into a softmax function with temperature T=0.1. These are then used as importance weights wᵢ for estimating how relevant the representation is learned by a particular expert for the target task's performance at client 110. Server 110 is configured to then use this data to weigh the individual data points x. More specifically, each source data x is assigned a probabilistic weighting:

$$p ( x ) = {\sum }_{i = 1}^{K} {w}_{i} {g}_{{i}_{θ}} ( x ) \frac{1}{\vert {S}_{i} \vert} \qquad ( 6 )$$

Here, |Sᵢ| represents the size of the subset that an expert e_{θi} was trained on. Server 120 is configured to weight the set of images associated to the i-th expert and uniformly sample from it. Server 120 is configured to construct a dataset by sampling examples from S at a rate according to p. Server 120 is configured to transmit the dataset to client 110.

In some embodiments, if client 110 and server 120 tasks are the same, then platform 100 is configured to perform domain adaptation in each of the subset S\hat{ } and the following generalization bound is used:

ε_{T}(h)<ε_{\dot{s}}(h)+ [symbol] (Ŝ,T) (7)

where ε represents the risk of a hypothesis function h∈H and d_{HΔH} is the HΔH divergence. H distinguishes between data points from S\hat{ } and T, respectively.

If the risk of the hypothesis function h on any subset S\hat{ } is similar such that ε_{S\hat{ }}(h)≈ε_{S}(h) for every S⊂P\hat{ }(S) and h∈H, minimizing equation 1 by platform 100 at server 120 can be equivalent to finding the subset S_{*} that minimizes the divergence with respect to T. That is:

$${𝒮}_{*} = {arg min}_{\hat{𝒮}} {d}_{ℋΔ ℋ ( \hat{𝒮} , 𝒯 )} \qquad ( 8 )$$

It may be difficult to compute d_{HΔH} and this can be approximated by a proxy A distance such as according to equation 9. For example, a classifier that discriminates between the two domains and whose risk is e can be used to approximate the second part of the equation.

[symbol]

≈\hat{d}_{A}≈2(1−2ε) (9)

Access to S and T may be provided in at least one of the two sides (e.g., to train the new discriminative classifier) and this may not be permitted in some embodiments. In some embodiments, instead, platform 100 generates the domain confusion between S\hat{ } and T by evaluating the performance of expert eᵢ on the target domain. This proxy task performance (or error rate) is an appropriate proxy distance that serves the same purpose but does not violate the data visibility condition. If the features learned on the subset cannot be discriminated from features on the target domain, the domain confusion is maximized. The correlation between the domain classifier and this proposed proxy task performance is shown in the experiments that follow.

### EXPERIMENTS

Various experiments using embodiments of platform 100 will now be described.

A) Toy Experiment—Domain Confusion

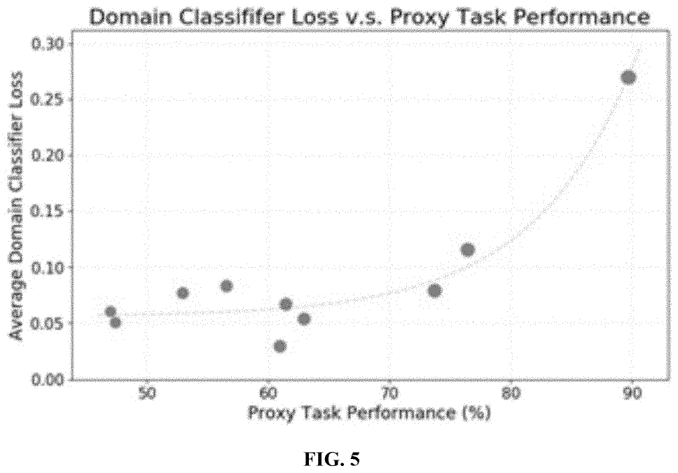

An experiment was performed to evaluate how well the performance of the proxy task reflects the domain confusion. The experiment compared the proxy task performance and \hat{d}_{A}(S\hat{ },T). To estimate \hat{d}_{A}, for each subset S\hat{ }, the domain confusion was estimated. FIG. 5 shows the domain confusion versus the proxy task performance using OxfordIIIT-Pets dataset as the target domain. In particular, this shows a relationship between a domain classifier and a proxy task performance on subsets S\hat{ }. In this plot, the highest average loss corresponds to the subset with the highest domain confusion (i.e., Si that is the most indistinguishable from the target domain). This correlates with the expert that gives the highest proxy task performance. A high domain confusion can indicate that the classifier is less able or unable to discriminate whether an image is from one domain (e.g., server data) or another domain (e.g., client data), and the data can be similar or almost indistinguishable from the point of view of the neural network.

B) Experimental Setup

Experiments were performed in classification, detection, and instance segmentation tasks on two server datasets and seven client datasets. In these experiments, expert models were first trained on the server 120 dataset S, and then the experts were used to select an optimal S* for each target dataset as described herein. The performance on the target task was evaluated by pre-training on the selected subset S* and using this as an initialization for training over the target dataset. For all self-supervised experts, ResNet18 was used, and the models were trained to predict image rotations.

I) Image Classification Setup

For classification tasks, Downsampled ImageNet was used as the server dataset. This is a variant of ImageNet resized to 32×32 resolution, with 1,281,167 training images from 1,000 classes. Several small classification datasets were used as target datasets. ResNet18 was used as the base network architecture, and an input size of 32×32 was used for all classification datasets. Once the subsets were selected, pre-train was performed on the selected S* and the transfer performance was evaluated by fine-tuning on client 110 (target) datasets.

II) Object Detection and Instance Segmentation Setup

For detection and segmentation experiments, MS-COCO was used as the server 120 dataset. The results were evaluated using the metrics on Cityscapes and KITTI as the target datasets. Mask R-CNN models were used with ResNet-FPN50 backbone, and a training procedure was used. All hyperparameters were fixed across all training runs and the choice of server data used for pre-training was varied.

C) Results and Analysis

The impact of pre-training data sampled using embodiments of platform 100 was investigated on the downstream performance. Table 1 shows example results for classification, object detection, and instance segmentation tasks by subsampling 20%, 40% of the source dataset to be used for pretraining. By carefully selecting a similar subset of pre-training data using platform 100, there is shown an improvement on all downstream tasks performance compared with pre-training on randomly selected subset of the same size. Moreover, when using 20% or 40% of pre-train data, we see comparable or improved performance of using the selected subset compared to pre-training on the entire 100% of pre-train data.

For classification tasks, methods implemented by platform 100 were compared with an alternative approach of sampling data based on the probability over source dataset classes computed by pseudo-labeling the target dataset with a classifier trained on the source dataset, this alternative approach being limited to the classification task, and unable to handle diverse tasks or scale to a growing dataserver. Platform 100 was shown to achieve comparable results to this alternative approach in classification, and can be additionally applied to source datasets with no classification labels such as MS-COCO or even datasets which are not labeled.

TABLE 1
Transfer learning results on classification, object detection, and instance segmentation.
Each row corresponds to data selection method, and the size of the subset is indicated (e.g.,
either 20% or 40% of the entire source dataset). Each column corresponds to a target dataset.

| | Target Task | Classification (% accuracy) | | Detection | | Segmentation | |
|---|---|---|---|---|---|---|---|
| | Source Dataset | Downsampled ImageNet | | (% box AP) COCO | | (% mask AP) COCO | |
| | Target Dataset | Oxford-IIIT Pets | CUB200 Birds | Cityscapes | KITTI | Cityscapes | KITTI |
| 0% | Random Initialization | 32.4 | 25.1 | 36.2 | 21.8 | 32.0 | 17.8 |
| 100% | Entire Dataset | 79.1 | 57.0 | 41.8 | 28.6 | 36.5 | 22.1 |
| 20% | Uniform Sample | 71.1 | 48.6 | 38.1 | 22.2 | 34.3 | 18.9 |
| | (Ngiam et al., 2018) | 81.3 | 54.3 | — | — | — | — |
| | Ours | 82.0 | 54.8 | 40.7 | 27.3 | 36.1 | 21.0 |
| 40% | Uniform Sample | 76.0 | 52.7 | 39.8 | 23.4 | 34.4 | 18.8 |
| | (Ngiam et al., 2018) | 81.0 | 57.4 | — | — | — | — |
| | Ours | 81.5 | 57.3 | 42.2 | 26.7 | 36.7 | 21.2 |

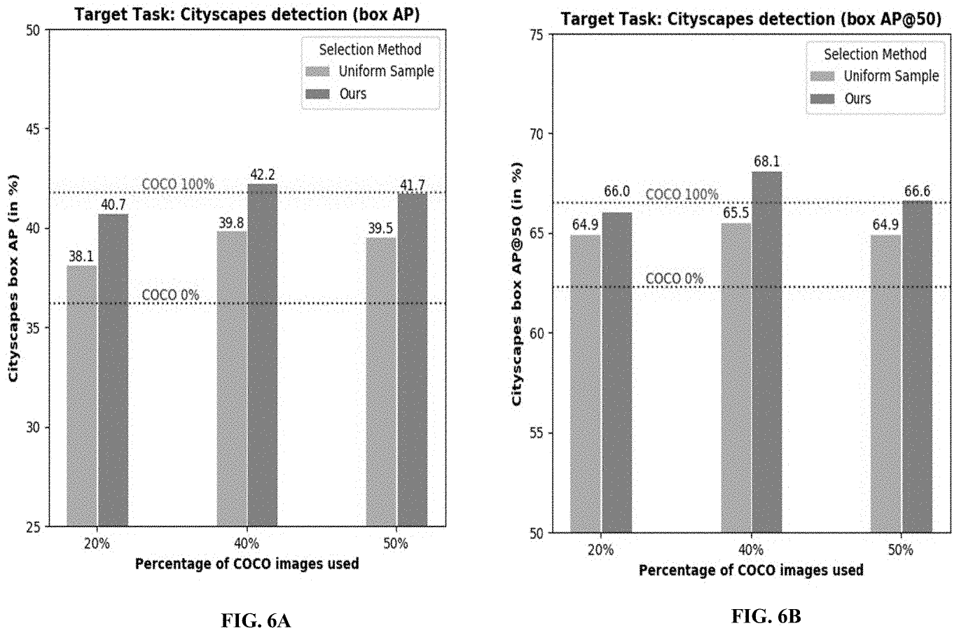

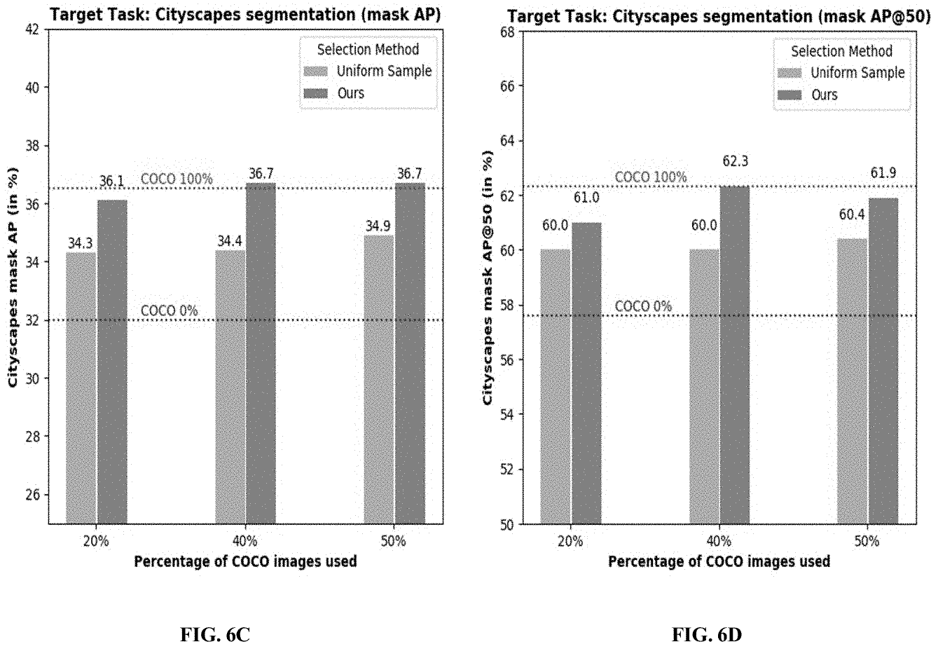

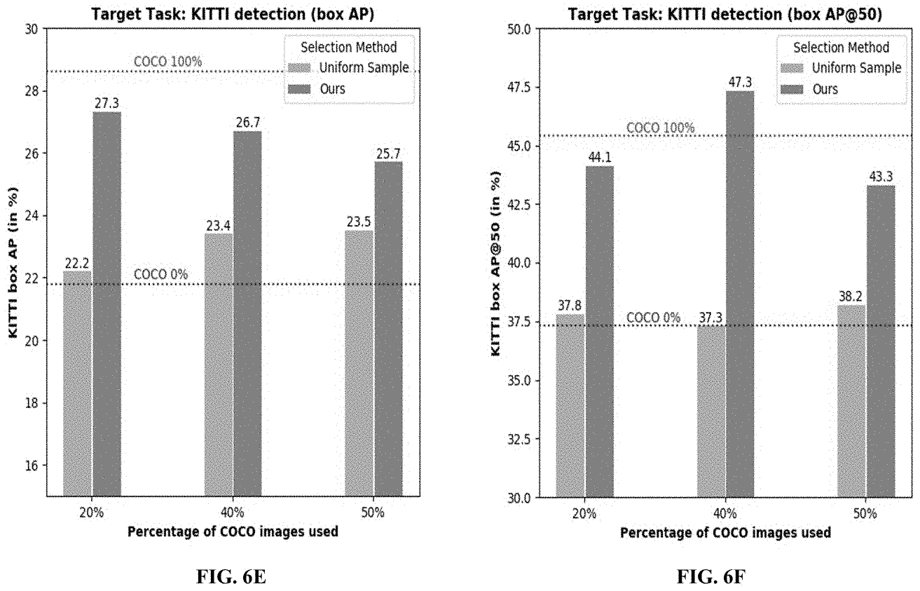

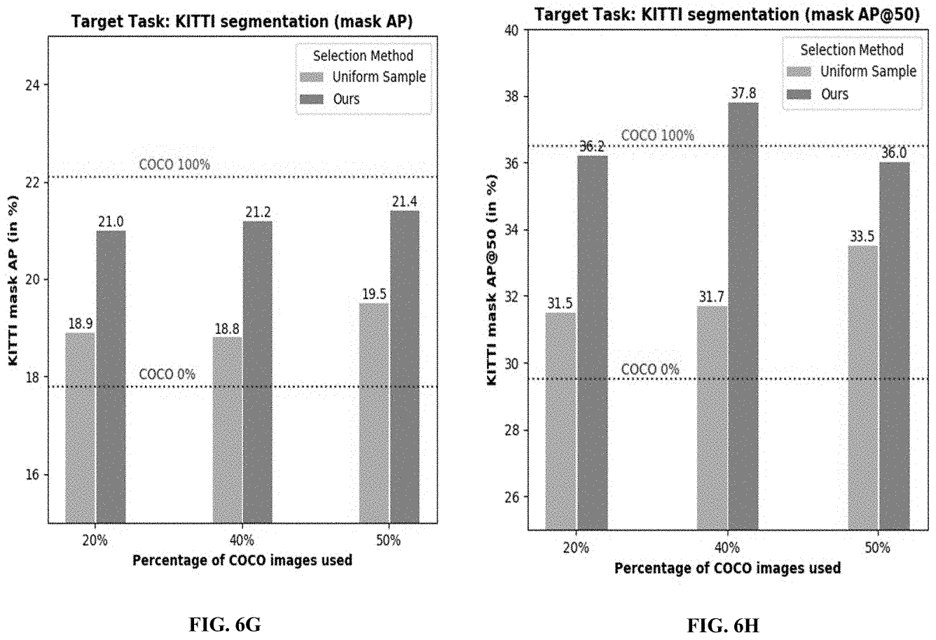

FIGS. 6A, 6B, 6C, 6D, 6E, 6F, 6G, and 6H show the AP (average precision averaged over intersection-over-union (IoU) overlap thresholds 0.5:0.95) and AP@50 (average precision computed at IoU threshold 0.5) for object detection and segmentation after fine-tuning the Mask R-CNN on Cityscapes and KITTI dataset, according to some embodiments. A general trend is that performance is improved by pre-training for the instance segmentation task using COCO compared to ImageNet pre-training (COCO 0%). This shows that a pre-training task other than classification is beneficial to improve transfer performance on localization tasks such as detection and segmentation, and shows the importance of training data. Next, we can see that pretraining using subsets selected by platform 100 according to some embodiments is 2-3% better than the uniform sampling baseline, and that using 40% or 50% of COCO yields comparable (or better) performance to using 100% of data for the downstream tasks on Cityscapes. Table 2 further shows the instance segmentation performance on the 8 object

TABLE 2
Transfer to object detection and instance segmentation with Mask R-CNN on
Cityscapes. Each row corresponds to a selection method and the percentage of MS-COCO
images used for pre-training.

| | | Target Dataset | | | | |
|---|---|---|---|---|---|---|
| Pre-Training Selection | | Stanford | Stanford | Oxford-IIIT | Flowers | CUB200 |
| Method | | Dogs | Cars | Pets | 102 | Birds |
| 0% | Random Initialization | 23.66 | 18.60 | 32.35 | 48.02 | 25.06 |
| 100% | Entire Dataset | 64.66 | 52.92 | 79.12 | 84.14 | 56.99 |
| 20% | Uniform Sample | 52.84 | 42.26 | 71.11 | 79.87 | 48.62 |
| | Fast Adapt (SP + TS) | 72.21 | 44.40 | 81.41 | 81.75 | 54.00 |
| | Fast Adapt (SP + SS) | 73.46 | 44.53 | 82.04 | 81.62 | 54.75 |
| | Fast Adapt (UP + SS) | 66.97 | 44.15 | 79.20 | 80.74 | 52.66 |
| 40% | Uniform Sample | 59.43 | 47.18 | 75.96 | 82.58 | 52.74 |
| | Fast Adapt (SP + TS) | 68.66 | 50.67 | 80.76 | 83.31 | 58.84 |
| | Fast Adapt (SP + SS) | 69.97 | 51.40 | 81.52 | 83.27 | 57.25 |
| | Fast Adapt (UP + SS) | 67.16 | 49.52 | 79.69 | 83.51 | 57.44 |

categories for Cityscapes.

| Size | Selection Method | box AP | mask AP | mask AP50 | car | truck | rider | bicycle | person | bus | mcycle | train |
|---|---|---|---|---|---|---|---|---|---|---|---|---|
| 0% | — | 36.2 | 32.0 | 57.6 | 49.9 | 30.8 | 23.2 | 17.1 | 30.0 | 52.4 | 17.9 | 35.2 |
| 20% | Uniform Sample | 38.1 | 34.3 | 60.0 | 50.0 | 34.2 | 24.7 | 19.4 | 32.8 | 52.0 | 18.9 | 42.1 |
| | Ours | 40.7 | 36.1 | 61.0 | 51.3 | 35.4 | 25.9 | 20.4 | 33.9 | 56.9 | 20.8 | 44.0 |
| 40% | Uniform Sample | 39.8 | 34.4 | 60.0 | 50.7 | 31.8 | 25.4 | 18.3 | 33.3 | 55.2 | 21.2 | 38.9 |
| | Ours | 42.2 | 36.7 | 62.3 | 51.8 | 36.9 | 26.4 | 19.8 | 33.8 | 59.2 | 22.1 | 44.0 |
| 50% | Uniform Sample | 39.5 | 34.9 | 60.4 | 50.8 | 34.8 | 26.3 | 18.9 | 33.2 | 55.5 | 20.8 | 38.7 |
| | Ours | 41.7 | 36.7 | 61.9 | 51.7 | 37.2 | 26.9 | 19.6 | 34.2 | 56.7 | 22.5 | 44.5 |
| 100% | — | 41.8 | 36.5 | 62.3 | 51.5 | 37.2 | 26.6 | 20.0 | 34.0 | 56.0 | 22.3 | 44.2 |

Table 3 compares different instantiations of platform 100 according to some embodiments on five classification datasets. For all instantiations, pre-training on a subset selected by platform 100 significantly outperforms the pre-training on a randomly selected subset of the same size. Table 3 shows that under the same superclass partition, the subsets obtained through sampling according to the transferability measured by self-supervised experts (SP+SS) yield a similar downstream performance compared to sampling according to the transferability measured by the task-specific experts (SP+TS). This shows that self-supervised training for the experts can successfully be used as a proxy to decide which data points from the source dataset are most useful for the target dataset, according to some embodiments.

Table 3. Ablation experiments on gating and expert training. SP stands for Superclass Partition, UP for Unsupervised Partition, TS for Task-Specific experts (experts trained on classification labels), and SS for Self-Supervised experts (experts trained to predict image rotation). Results reported are top-1 accuracy for all datasets.

In some embodiments, a platform 100 and method is provided that optimally or preferentially selects subsets of data from a large dataserver 120 given a particular target client 110. In particular, platform 100 is configured to represent the server 120's data with a mixture of experts trained on a simple self-supervised task. These are then used as a proxy to determine the most important subset of the data that the server 120 should send to the client 110. The method is shown experimentally to be general and applicable to a variety of many pre-training and fine-tuning schemes and that platform 100, in some embodiments, is configured to use data where no labeled data is available (e.g., only raw data at client 110 or server 120). In some embodiments, platform 100 provides a more effective computer-implemented functionality for transfer learning using massive datasets.

In some embodiments, there is provided a method for training a neural network for a target application. The method can first include a client requesting a dataset from a server relevant to the target application. Next, the server can receive the request. Next, a subset of data maintained by the server can be identified to be relevant to the target application by representing the data maintained by the server with a mixture of experts model, training the mixture of experts using data maintained by the server, optionally adapting the experts on a dataset of the client, and weighting the experts based on their accuracy. Finally, the server can select and communicate the dataset relevant to the target application to the client based on the weighting of the experts.

Although various embodiments have been described in detail, it should be understood that various changes, substitutions, and alterations can be made herein. Moreover, the scope of the present application is not intended to be limited to the particular embodiments of the process, machine, manufacture, composition of matter, means, methods and steps described in the specification.

As can be understood, the examples described herein and illustrated are intended to be exemplary only.

What is claimed is:

1. A computer-implemented method for selecting training data for a neural network, comprising:
representing a dataset with a mixture of experts model, the mixture of experts model comprising one or more trained neural networks; and
generating an application dataset based on one or more performance indicators of one or more of the trained neural networks.

2. The computer-implemented method of claim 1, wherein representing the dataset with the mixture of experts model comprises partitioning the dataset into one or more data subsets and training one or more neural networks each on one of the data subsets to generate the one or more trained neural networks.

3. The computer-implemented method of claim 2, the partitioning comprising k-means clustering over a set of features of a class of the dataset.

4. The computer-implemented method of claim 2, the partitioning comprising k-means clustering over a set of features of a pretrained neural network.

5. The computer implemented method of claim 2, the training of the one or more neural networks comprising self-supervised training on a pretext task.

6. The computer-implemented method of claim 1, further comprising adapting one of the one or more trained neural networks on a client dataset to generate one of the one or more performance indicators.

7. The computer-implemented method of claim 1, further comprising evaluating the performance of one of the one or more trained neural networks on a client dataset to generate one of the one or more performance indicators.

8. The computer-implemented method of claim 1, the one or more performance indicators generated by:
adapting one of the one or more trained neural networks on a client dataset when a first task for the dataset is the same as a second task for the application dataset; and
evaluating the performance of one of the one or more trained neural networks on the client dataset when the first task is not the same as the second task or when the second task is unknown.

9. The computer-implemented method of claim 1, wherein the application dataset is generated by sampling data points from the dataset at a rate according to a data point weighting generated for each of the data points, each data point weighting based on one of the one or more performance indicators.

10. The computer-implemented method of claim 1, wherein the one or more performance indicators are generated at a client.

11. The computer-implemented method of claim 1, further comprising transmitting the application dataset to a client for use in a target application.

12. A platform for training a neural network, comprising:
a server storing a representation of a dataset by a mixture of experts model, the mixture of experts model comprising one or more trained neural networks; and
an application dataset generated based on one or more performance indicators of one or more of the trained neural networks.

13. The platform of claim 12, wherein the one or more trained neural networks are generated by training one or more neural networks each on a data subset, the data subsets generated by partitioning the dataset.

14. The platform of claim 12, wherein the application dataset is generated by sampling data points from the dataset at a rate according to a data point weighting generated for each of the data points, each data point weighting based on one of the one or more performance indicators.

15. A computer product with non-transitory computer readable media storing program instructions to configure a processor to:
represent a dataset with a mixture of experts model, the mixture of experts model comprising one or more trained neural networks; and
generate an application dataset based on one or more performance indicators of one or more of the trained neural networks.

16. The computer product of claim 15, wherein the instructions configure the processor to represent the dataset with the mixture of experts model by partitioning the dataset into one or more data subsets and training one or more neural networks each on one of the data subsets to generate the one or more trained neural networks.

17. The computer product of claim 15, wherein the instructions configure the processor to generate the application dataset by sampling data points from the dataset at a rate according to a data point weighting generated for each of the data points, each data point weighting based on one of the one or more performance indicators.
